(19) United States
(12) Patent Application Publication
(10) Pub. No.: US 2009/0313772 A1
(43) Pub. Date: Dec. 24, 2009

(54) COMPOSITION COMPRISING PEROXYGEN AND SURFACTANT COMPOUNDS AND METHOD OF USING THE SAME

(76) Inventor: Charles Bullick Talley, Aurora, CO (US)

Correspondence Address: SHERIDAN ROSS PC, 1560 BROADWAY, SUITE 1200, DENVER, CO, 80202, US

(21) Appl. No.: 12/487,484

(22) Filed: Jun. 18, 2009

Related U.S. Application Data
(60) Provisional application No. 61/078,995, filed on Jul. 8, 2008.
(60) Provisional application No. 61/073,662, filed on Jun. 18, 2008.

(51) Int. Cl. B08B 9/00; E21B 43/00; C09K 8/524; B08B 3/08

(52) U.S. Cl. 15/3.5; 166/67; 507/90; 507/203; 507/277; 134/166 C

(57) ABSTRACT

The present invention relates generally to an additive composition for dissolving hydrocarbons. The composition includes a peroxygen compound and surfactant compounds.

### CROSS REFERENCE TO RELATED APPLICATION

The present application claims the benefits of U.S. Provisional Application Ser. Nos. 61/073,662, filed Jun. 18, 2008, and 61/078,995, filed Jul. 8, 2008, both entitled “A COMPOSITION COMPRISING PEROXYGEN AND SURFACTANT COMPOUNDS AND METHOD OF USING THE SAME”, each of which is incorporated herein by this reference

### FIELD OF THE INVENTION

The present invention relates generally to an additive composition comprising peroxygen and surfactant compounds, more specifically to a method of using an additive composition comprising peroxygen and surfactant compounds.

### BACKGROUND OF THE INVENTION

In today's economy, hydrocarbons are invaluable. They are used not only for fuel but most plastics. As hydrocarbon prices have risen, many attempts have been made to increase hydrocarbon recovery from oil and gas reservoirs.

“Enhanced Oil Recovery” (abbreviated “EOR”) is a generic term for techniques for increasing the amount of crude oil that can be extracted from an oil field. Using EOR, 30-60%, or more, of the reservoir's original oil can be extracted compared with 20-40% using primary and secondary recovery. Enhanced oil recovery is also called improved oil recovery or tertiary recovery (as opposed to primary and secondary recovery).

EOR refers to a large number of techniques. EOR techniques include gas injection, chemical injection, ultrasonic stimulation, microbial injection, and thermal recovery (which includes cyclic steam, steam flooding, and fireflooding).

Gas injection is presently the most-commonly used approach to enhanced recovery. A gas is injected into the oil-bearing stratum under high pressure. That pressure pushes the oil into the pipe and up to the surface. In addition to the beneficial effect of the pressure, this method sometimes aids recovery by reducing the viscosity of the crude oil as the gas mixes with it.

Several possible chemical EOR methods have been proposed. Some successful applications are injection of polymers, which can either reduce the crude's viscosity or increase the viscosity of water which has also been injected to force the crude out of the stratum. Detergent-like surfactants such as rhamnolipids, are injected to lower the capillary pressure that impedes oil droplets from moving through a reservoir.

Ultrasonic stimulation has been proposed to use high-power ultrasonic vibrations from a piezoelectric vibration unit lowered into the drillhead, to “shake” the oil droplets from the rock matrices, allowing them to move more freely toward the drillhead. This technique is projected to be most effective immediately around the drillhead.

In microbial injection, strains of microbes either partially digest long hydrocarbon molecules by generating biosurfactants or by emitting carbon dioxide (which then functions as described in gas injection above). Three approaches have been used to achieve microbial injection. In the first approach, bacterial cultures mixed with a food source (a carbohydrate such as molasses) are injected into the oil field. In the second approach, nutrients are injected into the ground to nurture existing microbial bodies. These nutrients cause the bacteria to increase production of the natural surfactants they normally use to metabolize crude oil underground. After the injected nutrients are consumed, the microbes go into near-shutdown mode, their exteriors become hydrophilic, and they migrate to the oil-water interface area, where they cause oil droplets to form from the larger oil mass, making the droplets more likely to migrate to the wellhead. The third approach addresses the problem of deposition of the paraffin components of the crude oil, which tend to separate from the crude as it flows to the surface. Since the earth's surface is considerably cooler than the petroleum-containing formations (a temperature drop of 13-14° F. per thousand feet of depth is usual), the paraffin's higher melting point causes it to solidify as it is cooled during the upward flow. Bacteria capable of breaking these paraffin chains into smaller chains (which would then flow more easily) are injected into the wellhead, either near the point of first congealment or in the rock stratum itself.

Finally in thermal recovery EOR techniques, various methods are used to heat the crude oil either during its flow upward in the drillhead, or in the pool, which would allow it to flow more easily toward the drillhead.

Although these EOR techniques can increase significantly oil recovery in many applications, they have limited success in others. This is so because many recovery obstacles result from clogging of wells by paraffins. Paraffins are not only hard to solubilize but also adhere strongly to other surfaces, particularly metal pipes. Of the EOR techniques, only microbial injection is able to decompose paraffins.

Additionally clogging can be caused by the well additives themselves. Cationic compounds, such as amines, and anionic compounds, such as sulfonates, are used together in sells for various purposes, such as controlling the viscosity of drilling mud. Calcium chloride is used to pressurize the well. In the well, calcium chloride forms calcium carbonate and sulfate. Operators attempt to remove clogs using hydrosulfuric acid, which is generally not successful.

### SUMMARY OF THE INVENTION

The present invention is directed generally to hydrocarbon solvents and various applications for such solvents.

In a first embodiment, a method includes the steps:

(a) providing a liquid additive composition, the liquid additive composition comprising a peroxygen compound, a surfactant, and at least about 20 wt. % alkalis; and

(b) contacting the liquid additive composition with a hydrocarbon-containing material to dissolve hydrocarbons in the hydrocarbon-containing material and form a hydrocarbon-containing liquid additive composition.

The additive composition can further include one or more of the following: a silicate (such as, but not limited to a metasilicate or sesquisilicate); and a chelator. The alkali content is preferably provided by a builder (such as, but not limited to sulfates, carbonates, and sesquicarbonates.

The peroxygen compound can be any peroxygen compound, such as, but not limited to hydrogen peroxides, persulfates, thiourea dioxides, percarbonates, perborates, diethylhydroxylamines, persulfates, and peracetic acids, more preferred are perborates and percarbonates.

The additive composition is solubilized in one of an aqueous liquid, a non-aqueous liquid, or a mixture thereof. Non-limiting examples of non-aqueous liquids are methanol, ethanol, butanol, t-butanol, and ethanolamine. Non-limiting examples of aqueous liquids are: water, aqueous brines; sea, lake and/or river waters; subsurface waters, or mixtures thereof.

In a second embodiment, a mixture includes:

(a) a peroxygen compound;

(b) a surfactant;

(c) a chelate;

(d) a silicate; and

(e) dissolved hydrocarbons.

In a third embodiment, a liquid mixture includes:

(a) one or more low HLB surfactants;

(b) one or more high HLB surfactants;

(c) one or more peroxygen compounds,

(d) dissolved hydrocarbons, wherein at least one of the following is true for the mixture:
an oxidation potential of at most about −100 mV versus a standard hydrogen electrode;
a surface tension of at most about 28 dynes; and
an Na₂O meq value at a pH of about pH 8 of at least about 20 meq.

The mixtures are commonly formed when the additive composition is contacted with a hydrocarbon-containing material.

Another aspect of the present invention is a method of using the additive composition. One embodiment is a method of using the additive composition in a petroleum production process. Non-limiting examples of using the additive composition in petroleum production are: additive and/or stimulating a petroleum-containing material; additive and/or stimulating a petroleum-producing well; recovering petroleum from the petroleum-containing material; and additive petroleum production and/or transporting equipment. Petroleum means any hydrocarbon-compound or mixture of hydrocarbon-compounds, such as, but not limited to: crude oil (heavy, intermediate, and light grades); shale oil; and/or tar.

In a fourth embodiment, a well includes:

(a) a downhole casing;

(b) a wellhead; and

(c) a liquid additive composition in at least part of the downhole casing, the liquid additive composition having the following properties:
an oxidation potential of at most about −100 mV versus a standard hydrogen electrode;
a surface tension of at most about 28 dynes; and
an Na₂O meq value of at least about 20 meq at a pH of about pH8.

In a fifth embodiment, a pipeline includes:

(a) a conduit, the conduit comprising at least one of paraffins, asphaltenes, malthas, gilsonites, and bitumenes; and

(b) a liquid additive composition comprising a peroxygen compound, a silicate, and a surfactant, the liquid additive composition being in contact with the at least one of paraffins, asphaltenes, malthas, gilsonites, and bitumenes.

The above embodiments can provide a number of advantages. For example, the additive composition and methods can, relative to conventional EOR methods, increase significantly oil recovery in many applications. This is so because the additive composition can dissolve not only valuable hydrocarbons but also other hydrocarbons. Relative to conventional EOR methods, significant increases in hydrocarbon recoveries can result from the surprising ability of the additive composition to dissolve paraffins and asphaltenes. The composition appears to reduce the high zeta potential of paraffins and asphaltenes. The composition can also remove clogging caused by calcium carbonate and sulfate deposits. The mixture formed from the composition and dissolved hydrocarbons can produce a cleaner split of produced water and hydrocarbons. Typically, produced water includes about 3 wt. % hydrocarbons. The additive composition can reduce significantly the amount of hydrocarbons in the recovered produced water. The use of an electrolytic cell to ionize the water in which the additive composition is dissolved can increase significantly the caustic level over the additive composition in the absence of water ionization. The ionization potential in the water molecule, as a result of ionization, can enable the additive composition to dissolve paraffins and asphaltenes faster than the composition alone.

These and other advantages will be apparent from the disclosure of the invention contained herein.

An “alkali” refers to any compound that has highly basic properties. Alkalis are often hydroxides of alkali metals (metals that belong to Group IA of the periodic table, including lithium (Li), sodium (Na), potassium (K), rubidium (Rb), cesium (Cs), and francium (Fr). Alkalis are strong bases that turn litmus paper from red to blue; they react with acids to yield neutral salts; and they are caustic and in concentrated form are corrosive to organic tissues. The term alkali is also applied to the soluble hydroxides of such alkaline-earth metals as calcium, strontium, and barium and also to ammonium hydroxide.

An “asphaltene” is a component of bitumen.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B or C” and “A, B, and/or C” means A alone, B alone, C alone, A and B together, A and C together, B and C together, or A, B and C together.

“Bitumen” is a mixture of hydrocarbons.

A “builder” is a substance added to soaps or detergents to increase their cleansing action.

A “chelate” is a type of coordination compound in which a central metal ion, such as Co²⁺, Ni²⁺, Cu²⁺, or Zn²⁺, is attached by coordinate links to two or more nonmetal atoms in the same molecule, called ligands. Heterocyclic rings are formed with the central (metal) atom as part of each ring. Ligands offering two groups for attachment to the metal are termed bidentate (two-toothed); three-groups, tridentate; etc. A common chelating agent is ethylene-diaminetetraacetic acid, N-hydroxyethylenediaminetriacetic acid, (poly) alkylphosphonic acid, nitrilotriacetic acid, and ethyleneglycol-bis(β-aminoethyl ether)-N,N-tetraacetic acid.

“Crack” refers to the thermal decomposition of a substance, such as the thermal decomposition of crude petroleum, to produce petrol/gasoline.

“Dissolve” refers to the formation of a solution from two or more substances. Typically, the solution is a homogeneous mixture composed of the two or more substances. In such a mixture, a solute is dissolved in another substance, known as a solvent.

A “gelling agent” is a material used to thicken and stabilize liquid solutions, emulsions, and suspensions. They dissolve in the liquid phase as a colloid mixture that forms an internal structure giving the resulting gel an appearance of a solid matter, while being mostly composed of a liquid. Typical gelling agents include natural gums, starches, pectins, agar and gelatin. Often they are based on polysaccharides or proteins. Exemplary gelling agents include alginic acid (E400), sodium alginate (E401), potassium alginate (E402), ammonium alginate (E403), calcium alginate (E404), and polysaccharides.

A “hydrocarbon” is an organic compound exclusively including elements of carbon and hydrogen. The principal types of hydrocarbons include aliphatic (straight-chain) (which includes paraffins or alkanes, olefins, alkenes, alkalidienes, acetylenes, and acyclic terpenes) and cyclic (closed ring) (which includes alicyclic (cycloparaffins, cycloolefins, and cycloacetylenes), aromatic (which includes the benzene group, naphthalene group, and anthracene group), and cyclic terpenes.

“Kerogen” is an organic compound of oil shale and is normally a mixture of aliphatic and aromatic compounds of humic and algal origin.

“Oil” is applied to a wide range of substances and can be classified by type and function. The primary classification discussed herein is mineral (petroleum (aliphatic or wax-base, aromatic or asphalt-base, and mixed base) and petroleum-derived).

A “paraffin” is a class of aliphatic hydrocarbons characterized by a straight or branched carbon chain.

A “peroxygen compound” is a compound comprising the peroxide ion. The peroxide ion is an oxygen-containing ion in which the two atoms of oxygen are linked by a single bond.

“Solubility” refers to the state or quality of being soluble, capability of being melted or dissolved; amount of a substance that can be dissolved in a solvent.

“Solubilize” refers to making soluble or increasing solubility.

“Soluble” means the degree to which a substance dissolves in a solvent to make a solution (usually expressed as grams of solute per litre of solvent). Solubility of one fluid (liquid or gas) in another may be complete (totally miscible; e.g., methanol and water) or partial (oil and water dissolve only slightly).

A “surfactant”, or surface-active agent, is any compound that reduces surface tension when dissolved in water or water solutions or which reduces interfacial tension between two liquids or between a liquid and solid. There are generally three categories of surface-active agents, namely detergents, wetting agents, and emulsifiers.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIGS. 1A-1C depict a process in accordance with an embodiment;

FIGS. 2A-2C depict another process in accordance with another embodiment;

FIGS. 3A-3C depict another process in accordance with another embodiment;

FIGS. 4A-4C depict another process in accordance with another embodiment;

FIG. 5 is a schematic flowchart of a process according to an embodiment;

FIG. 6 is another schematic flowchart of another process according to another embodiment;

FIG. 7 is another schematic flowchart of another process according to another embodiment;

FIGS. 8A-8F depict another process in accordance with another embodiment;

FIG. 9 depicts another process in accordance with another embodiment;

FIG. 10 is another schematic flowchart of another process according to another embodiment;

FIG. 11 is another schematic flowchart of another process according to another embodiment; and

FIG. 12 is another schematic flowchart of another process according to another embodiment.

### DETAILED DESCRIPTION

### The Additive Composition

The additive composition, when dissolved in a solvent such as water, has certain properties for enhanced results. Preferably, the composition is nonionic when dissolved in water. Preferably, the oxidation potential of the additive composition is at most about −100 mV versus a standard hydrogen electrode (SHE), preferably at most about −200 mV versus SHE, and more preferably at most about −250 mV versus SHE. Preferably, the surface tension of the additive composition is at most about 28 dynes, preferably at most about 24 dynes, and more preferably at most about 22 dynes. Preferably, the additive composition has a sufficient amount of surfactants and alkalis to maintain paraffins and asphaltenes in suspension. In one formulation, the additive composition preferably comprises at least about 20 wt. % alkalis, even more preferably at least about 30 wt. %, and even more preferably from about 30 to about 40 wt. % alkalis and has a pH of at least about pH 11 and even more preferably ranging from about pH 12.5 to about pH 13. The additive composition commonly has an Na₂O meq value of preferably at least about 20 meq at a pH of about pH 8, more preferably about at least 25 meq, and even more preferably a Na₂O meq value of least about 30 meq at a pH of about pH 8. In one formulation, the additive composition has a Na₂O meq value at a pH of about pH 4 preferably of at least about 25 meq, more preferably about at least 35 meq, and even more preferably a Na₂O meq value at a pH of about pH 4 of least about 40 meq.

In one embodiment, the additive composition is the composition described in U.S. Pat. Nos. 6,043,207, with an issue date of Mar. 28, 2000, entitled “Non-Caustic Additive Comprising Peroxygen Compound, Meta/Sesqui-Silicate, Chelate and Method of Making the Same in Free-Flowing, Particulate Form” and 6,194,367, with an issue date of Feb. 27, 2001, entitled “Non-Caustic Additive Comprising Peroxygen Compound and Specific Silicate and Method of Making the Same in Free-Flowing Particulate Form” both to Talley, each of which is incorporated fully herein by this reference in their entirety. In these patents, Talley teaches an alkaline additive for removing protein, grease, and other organic deposit and stains from articles such as those used in the food industry.

In this formulation, the additive composition preferably includes (a) a peroxygen compound, (b) a silicate, (c) a builder, (d) a surfactant, and (e) a chelate. Preferably, the additive composition is substantially free of chlorine-containing compounds and hydroxides. In a preferred embodiment, the silicate is a metasilicate and/or sesquisilicate. The composition may include a gelling agent. The additive composition is typically in a dry, granulated form which is dissolved in a carrier, such as water, to form a liquid additive composition before use.

While not wishing to be bound by any theory, it is believed that the peroxygen compound releases the peroxide ion that not only kills microbes but also reacts with H₂S to form sulfates and/or sulfuric acid, which is neutralized by carbonate deposits. The silicate is believed to carry the charge and maintain the surfactant in the aqueous solution. The builder is believed to provide sufficient alkalinity to peptize, emulsify, and/or saponify paraffins, asphaltenes, and other hydrocarbons. The chelate is believed to dissolve alkaline earth metals, particularly Ca²⁺, in surrounding deposits and tie up dissolved metals, which would otherwise react with and neutralize the peroxide ion. The surface-active agent, or surfactant, is believed to provide enhanced penetration into the rock pores and fractures and cleave hydrocarbons.

The peroxygen compound preferably includes a hydrogen peroxide, persulfate, thiourea dioxide, perborate, percarbonate, diethylhydroxylamine, and/or peracetic acid, even more preferably a perborate and/or percarbonate and even more preferably a percarbonate. The peroxygen compound can be complexed with a metal, preferably an alkali or alkaline earth metal selected from the group including sodium, lithium, calcium, potassium, and boron. The additive composition preferably includes at least about 25% by weight, more preferably from about 25% to about 40% by weight, and even more preferably from about 25% to about 35% by weight of the peroxygen compound.

The silicate is preferably a metasilicate and/or sesquisilicate. The silicate is preferably in the anhydrous form and is normally compounded with an alkali or alkaline earth metal. The alkali metal is preferably one or more of sodium and potassium. The additive composition preferably includes at least about 15% by weight, more preferably from about 20% to about 40% by weight, and most preferably from about 25% to about 35% by weight of the silicate.

The builder can be any suitable builder. Preferably, the builder is one or more of a sulfate, carbonate, phosphate, and sesquicarbonate. The sulfate is, for example, an alkali or alkaline earth metal sulfate, with sodium sulfate being preferred. The phosphate is preferably a tripolyphosphate, trisodium polyphosphate, sodium potassium pyrophosphate, sodium hexametaphosphate, disodium phosphate, and/or monosodium phosphate. The carbonate is preferably one or more of an alkali or alkaline earth metal carbonate, sesquicarbonate, bicarbonate. When the additive composition includes a surfactant, the carbonate and phosphate are preferably in the hydrated form, such as trona or soda ash. In one formulation, the builder comprises a phosphate in an amount ranging from about 5 to about 15 wt. % and even more preferably from about 7.5 to about 12.5 wt. %.

While not wishing to be bound by any theory, it is believed that the hydrated builders, such as the hydrated phosphates and/or carbonates, form bonds with the surfactants which are hydrophilic substances, thereby immobilizing the surfactant and water. As will be appreciated, the surfactant and water will react with the peroxygen compound unless the surfactant and water are immobilized. The reaction reduces and therefore neutralizes the peroxygen compound while causing the release of oxygen gas. The reaction not only adversely impacts the shelf life and hydrocarbon removal efficiency of the additive composition but also can cause a hazardous pressure build up from the released oxygen gas. The use of adequate amounts of hydrated builders has been found to substantially eliminate these problems.

The amount of hydrated builder in the additive composition normally depends upon the amount of surfactant in the additive composition. Preferably, the molar ratio of the hydrated builder to the surfactant is at least about 4 parts of hydrated builder to one part surfactant, more preferably ranges from about 6 to about 22 parts of hydrated builder to one part surfactant, and even more preferably ranges from about 8 to about 10 parts of hydrated builder to one part surfactant. The total amount of builder in the additive composition (both in the hydrated and anhydrous forms) varies depending upon the application. The additive composition preferably includes at least about 20 wt. % by weight, more preferably from about 20% to about 75% by weight, and even more preferably from about 25% to about 50% by weight of the builder.

It has been discovered that phosphate builders have several beneficial effects on the performance of the additive composition in addition to immobilizing the surfactant in water. The phosphate helps the chelate tie up free metals. In sufficient amounts of the phosphates, dry blending of the additive composition is much less difficult. Preferably, the additive composition contains from about 3% to about 15% by weight phosphates.

The additive composition can further include a surfactant. The surfactant should be functional in an alkaline solution. Suitable surfactants are nonionic, anionic and amphoteric surfactants.

Preferred nonionic surfactants include octylphenoxy-polyethoxy-ethanol (e.g., sold under the trademark TRITON X-100), nonyl phenoxy ethyleneoxy ethanol (e.g., sold under the trademark IGEPAL CO730), nonylphenoxypoly(ethyleneoxy) ethanol (e.g., sold under the trademark IGEPAL CO630), octylphenoxypoly(ethyleneoxy) ethanol (e.g., sold under the trademark IGEPAL 630), polyoxy ethoxylated ethanol (e.g., sold under the trademark RENEX ZO), glycol fatty esters (e.g., sold under the trademark HALLCO-376-N), fatty acid alkylanolamid (e.g, sold under the trademark ALKAMIDE 2110), cetyldimethyl amine oxide (e.g., sold under the trademark AMMONYX CO), aliphatic polyether (e.g., sold under the trademark ANTAROX LF-344), polyethylenated alkyl glycol amide (e.g., sold under the trademark ANTAROX G-200), fatty alcohol polyether (e.g., sold under the trademark AROSURE 63-PE-16), polyoxyethylene sorbitol esters of mixed fatty and resin acids (e.g., sold under the trademark ATLAS G-1234), modified oxyethylated straight-chain alcohol (e.g., sold under the trademark RENEX 648), modified oxyethoxylated straight-chain alcohols (e.g. sold under the trademark PLURAFAC RA, ZO), PO/EO block copolymer alcohols of propylene oxide (PO)/ethylene oxide (EO) (e.g., sold under the tradename PLURONIC® 25-R-2), alkylaryl polyether (e.g., sold under the trademark TRITON CF10), trifunctional polyoxyalkylene glycols (e.g., sold under the trademark PLURADOT HA-410), diethylene glycol dioleate, polyethylene glycol recinaleate, polyethylene glycol dioleate, tridecyl alcohol, nonylphenol, and ethylene oxide condensation products that are based on propylene oxide-propylene glycol (e.g., sold under the trademark PLURONIC L-61), ethoxylated alkylphenols (e.g., sold under the trademarks IGEPAL RC-620, ALKASURF OP-12, and TRITON N-101), propoxylated and ethoxylated fatty acids, alcohols, or alkylphenols (e.g., sold under the trademarks TRITON XL-80N and ANTAROX BL-330), ethoxylated alcohols (e.g., sold under the trademarks PLURAFAC A, TRITON CF-54, TERGITOL TMN-6, and TERGITOL 15-5-7), alkoxylated linear aliphatic alcohol (e.g., sold under the trademark OLIN SL-42), and alcohol alkoxylate (e.g., sold under the trademark SURFONIC LF-17). Preferred anionic surfactants include ethoxylated (3 moles) phosphate ester (e.g., sold under the trademark TRITON QS-44), sodium sulfate of 2 ethyl-a-hexanol (e.g., sold under the trademark TERGITOL 08), sodium petroleum sulfonate (e.g., sold under the trademark PETRONATE K), sodium alkyl naphthahalene sulfonate (e.g., sold under the trademark PETRO AR, SELLOGEN K, NEKAL BX-78, ALKANOL B), primary alkane sulfonate (e.g., sold under the trademark BIO TERG PAS-8S), dioctyl ester of sodium sulfosuccinic acid (e.g., sold under the trademark ABRESOL OT), sodium alkylaryl sulfonate (e.g., sold under the trademark AHCOWET ANS), sodium salt of sulfated alkylphenoxy poly(ethyleneoxy) ethanol (e.g., sold under the trademark ALIPAL EO-526), sodium methyl n-oleyl-taurate (e.g., sold under the trademark AMATER G T), alkyl polyphosphate (e.g., sold under the trademark ATCOWET C2), sodium lauryl sulfate (e.g., sold under the trademark AVIROL 101), sodium N-methyl-N-tall oil acid taurate (e.g., sold under the trademark IGEPON TK-32), lauric alkyloamine condensate (e.g., sold under the trademark NOPCOGEN 14-L), fatty alcohol sulfate modified (e.g. sold under the trademark RICHOLOL 4940), modified diethanolamides of fatty acids (e.g., sold under the trademark SHERCOMID), sulfates of alcohols (e.g., sold under the trademark STANDOPAL LF), sulfonates of naphthalene and alkyl naphthalene (e.g., sold under the trademark PETRO WP) and alkanolamides (e.g., sold under the trademark NOPCO 1179). Preferred amphoteric surfactants include disodium N-tallow betamino dipropionate (e.g., sold under the trademark DERIPHATE 154), sodium derivative of dicarboxylic caprylic acid (e.g., sold under the trademark MIRANOL J2M, letithin (e.g., sold under the trademark CENTROL CA, LA), lauryl ampholytic (syndet) (e.g., sold under the trademark SCHERCOTERIC BASE 156), carboxylic acid derivatives of substituted imidazolines (e.g., sold under the trademark MONATERIC), complex coco betaine (e.g., sold under the trademark CARSONAM 3 AND 3147), fatty sulfobetaine (e.g., sold under the trademark LONZAINE CS), dicarboxylic coconut derivative triethanolamine (e.g., sold under the trademark MIRANOL TEA), dicarboxylic octoic derivative sodium salt (e.g. sold under the trademark MIRANOL JEM), dicarboxylic myristic derivative diethanolamine (e.g., sold under the trademark MIRANOL M2M-DEM), dicarboxylic myristic derivative monoethanolamine (e.g., sold under the trademark MIRANOL M2M-MEA), dicarboxylic myristic derivative sodium salt (e.g., sold under the trademark MIRANOL M2M-SF), dicarboxylic capric derivative diethanolamine (e.g., sold under the trademark MIRANOL S2M-DEA), imidazolnes and imidazline derivatives (e.g., sold under the trademark MONATERIC 949-J), dicarboxylic capric derivative triethanolamine (e.g., sold under the trademark MIRANOL S2M-TEA), and other amphoteric surfactants (e.g., sold under the trademark PHOSPHOTERIC T-C6).

Even more preferred surfactants include (i) the nonionic surfactants, nonylphenoxypoly(ethyleneoxy) ethanol (e.g., sold under the trademark IGEPAL CO630), octylphenoxypoly(ethyleneoxy) ethanol (e.g., sold under the trademark IGEPAL 630), ethoxylated alkylphenols (e.g., sold under the trademarks IGEPAL RC-620, ALKASURF OP-12, and TRITON N-101), propoxylated and ethoxylated fatty acids, alcohols, or alkylphenols (e.g., sold under the trademarks TRITON XL-80N and ANTAROX BL-330), ethoxylated alcohols (e.g., sold under the trademarks PLURAFAC A, TRITON CF-54, TERGITOL TMN-6, and TERGITOL 15-5-7), alkoxylated linear aliphatic alcohol (e.g., sold under the trademark OLIN SL-42), diethylene glycol dioleate, polyethylene glycol recinaleate, polyethylene glycol dioleate, tridecyl alcohol, nonylphenol, and ethylene oxide condensation products that are based on propylene oxide-propylene glycol (e.g., sold under the trademark PLURONIC L-61), block copolymer alcohols (e.g., sold under the tradename PLURONIC® 25-R-2), and alcohol alkoxylate (e.g., sold under the trademark SURFONIC LF-17); (ii) the anionic surfactants, primary alkane sulfonate (e.g., sold under the trademark BIO TERG PAS-8S), sulfates of alcohols (e.g., sold under the trademark STANDOPAL LF), sulfonates of naphthalene and alkyl naphthalene (e.g., sold under the trademark PETRO WP), and alkanolamides (e.g., sold under the trademark NOPCO 1179); and (iii) the amphoteric surfactants, imidazolnes and imidazline derivatives (e.g., sold under the trademark MONATERIC 949-J), and the amphoteric surfactant sold under the trademark PHOSPHOTERIC T-C6.

Even more preferred surfactants include the low foaming surfactants, primary alkane sulfonate sold under the trademark BIO TERG PAS-8S, block copolymer alcohols (e.g., sold under the tradename PLURONIC® 25-R-2), and propylene oxide and ethylene oxide block polymer sold under the trademark PLURONIC L-61 and the high foaming surfactants, nonylphenoxypoly(ethyleneoxy) ethanol sold under the trademark IGEPAL CO 630 and octylphenoxypoly(ethyleneoxy) ethanol sold under the trademark IGEPAL CA 630.

In one formulation, the additive composition comprises one or more low HLB surfactants and one or more high HLB surfactants. In one formulation, the low HLB surfactant is a surfactant having an HLB value less than about 12, preferably less than about 10, and more preferably less than about 8. Non-limiting examples of the low HLB surfactants are BioTerg® PAS-85, having an HLB value of about 12, and Pluronic® 25-R-2, having an HLB of about 4. In another formulation, the high HLB surfactant is a surfactant having an HLB value greater than about 8, preferably greater than about 10, and more preferably greater than about 12. Non-limiting examples of the high HLB surfactants are Pluronic® L-61, having an HLB value of about 16, and Tomadol® 91-6, having an HLB value of about 12.5.

In one formulation, the additive composition includes preferably from about 0.01 to about 1.0 wt. % and even more preferably from about 0.05 to about 0.5 wt. % of a fluorocarbon surfactant sold by DuPont under the tradename Capstone FS-51 to impart heat and pressure resistance to the composition. The fluorocarbon surfactant has an HLB value of about 18 and has been found to provide enhanced recovery of kerogen from oil shale and hydrocarbon recovery from deeper hydrocarbon-containing formations.

The amount of the surfactant in the additive composition can be important to the effectiveness of the additive composition. Preferably, the additive composition contains at least about 2.5% by weight and more preferably from about 2.5% to about 10% by weight, and most preferably from about 2.5% to about 8% by weight of the surfactant.

The chelate can be any suitable chelate. Preferably, the chelate is a derivative of a carboxylic, phosphoric, or phosphonic acid. More preferably, the chelate is selected from the group consisting of EDTA, NTA, and other derivatives of a carboxylic acid, phosphoric acid, and phosphonic acid, such as poly(alkylphosphonic acid) (e.g., sold under the trademark ACUSOL 505ND) and tripolyphosphates. The EDTA acid is preferably in the form of an alkali or alkaline earth metal salt, such as a sodium salt (“ETDA-Na₄”) or a potassium salt, as the salt is more water soluble than the acid. The additive composition preferably includes at least about 2% by weight, more preferably an amount ranging from about 2% to about 8% by weight, and even more preferably an amount ranging from about 4% to about 6% by weight of the chelate, with the optimum amount being about 5% by weight.

In one formulation, the peroxygen compound, silicate, and chelate are salts having the same cation. More preferably, all of the salts in the additive composition have the same cation. The preferred cation is an alkali metal, such as sodium or potassium.

The ratios of the various components can be important parameters in many applications. Preferably, the weight ratio of the peroxygen compound to the chelate ranges from about 3:1 to 7:1 and more preferably is about 6:1. The preferred weight ratio of the metasilicate and sesquisilicate on the one hand to the surfactant on the other preferably ranges from about 5:1 to about 15:1 and most preferably is about 9:1. The preferred weight ratio of the metasilicate and sesquisilicate on the one hand to the peroxygen compound on the other preferably ranges from about 1:1 to about 2:1 and is more preferably about 1:1. The preferred weight ratio of the metasilicate and sesquisilicate on the one hand to the chelate on the other preferably ranges from about 5:1 to about 15:1 and most preferably is about 6:1.

The additive composition can also include a gelling agent to provide a gel formulation for applying the additive composition to accessible hydrocarbon deposits, such as hydrocarbon deposits on petroleum refinery equipment. The cleaning ability of the additive composition can be facilitated by the adherence properties of the gel. For instance, such gel formulations are particularly useful for hydrocarbon deposits on hydrocarbon carrying equipment, such as pipelines. Preferred gelling agents include carboxymethyl cellulose, hydroxymethylcellulose and modified polyacrylamide. The preferred concentration of the gelling agent in the additive composition ranges from about 6% to about 12% by weight.

To apply the additive composition with a gelling agent, the additive composition is preferably combined with from about 7 to about 14 parts by weight water and the mixture is placed in a pressurized vessel at about 160 psi. As the pressure is released, the mixture is ejected from the vessel onto the object to be cleaned. The mixture can include a foam builder such as nonylphenoxy polyethoxyethanol to enhance the foaming characteristics of the mixture.

The above-noted components of the additive composition are combined by suitable techniques for forming granulated cleaners. For example, the various components are added to a vessel as follows: (i) the various builders are added first, preferably in an anhydrous form, and blended together, (ii) the surfactant is added second and blended with the builders, (iii) water is added after or simultaneously with the surfactants and blended with the surfactants and builders for a sufficient period of time for substantially all of the water to form hydrates with the builder(s), (iv) the silicate, chelate, and peroxygen compound are added in that order, and (v) the gelling agent, if used, is added last. The various components can be blended with any suitable device. In the preceding steps, the peroxygen compound is preferably maintained separate from water and the surfactant as the peroxygen compound will react with water and/or the surfactant, thereby releasing oxygen and neutralizing the peroxygen compound. Thus, the surfactant is preferably added to the vessel before the peroxygen compound.

The addition of water in the third step is preferably carefully controlled. If too much water is added, the resulting additive composition will not be a free flowing particulate, as desired, but will be a highly viscous mass. If too little water is added, the surfactant may not be immobilized and can react with the peroxygen compound. Preferably, the minimum amount of water added is the stoichiometric amount that is sufficient to form hydrates with substantially all of the hydratable builders and the maximum amount of water added is no more than about 150% and more preferably no more than about 125% of the stoichiometric amount. By way of example, if sodium carbonate (Na₂CO₃) is the hydratable builder the molar ratio of sodium carbonate to water preferably ranges from about 50:1 to about 175:1 and most preferably from about 100:1 to about 150:1. In most applications, the molar ratio of hydratable builders to water also ranges from about 50:1 to about 175:1 and more preferably from about 100:1 to about 150:1, and the total amount of water added to the additive composition in the third step and total amount of water in the additive composition, whether occurring as free or hydrated molecules, ranges from about 0.1 to about 0.5% by weight of the final additive composition, with 0.1% by weight being most preferred. The free moisture content of the additive composition is preferably no more than about 0.1% by weight of the additive composition.

The blending time of the third step is preferably carefully controlled to substantially minimize the amount of free water molecules present in the additive composition. The water/surfactant/builder blend is preferably blended for a sufficient period of time for the water to react with substantially all of the hydratable builders and for substantially all of the surfactant to form bonds with the hydrated builders. Preferably, the blending in the third step has a duration of at least about 5 minutes after water addition and more preferably ranging from about 5 to about 10 minutes.

As noted above, the additive composition is preferably a dry, granular material. Before use, the additive composition can be dissolved in water, or other suitable carrier, to form a liquid additive composition. To ensure that the additive composition dissolves rapidly in cold or luke warm water, the particle sizes of the various ingredients are that of a light density material. Light density materials have a large surface area allowing quicker solubility in cold or luke warm water. Preferably, the additive composition has a mean particle size ranging from about 20 to about 100 mesh (Tyler), more preferably from about 30 to about 60 mesh (Tyler), and most preferably from about 30 to about 50 mesh (Tyler). The preferred concentration of the additive composition in the additive solution is discussed below. The liquid additive composition preferably has pH ranging from about pH 9 to about pH 13 and more preferably from about pH 11 to about pH 12.

The concentration of the additive composition in the additive solution depends upon the type of hydrocarbon deposit to be removed and the application technique. In most applications, the preferred aqueous concentration of the additive composition in the additive solution ranges from about 0.1 to about 8 and even more preferably from about 0.25 to about 5 percent by weight.

After blending with water or another solvent, the liquid additive composition commonly comprises at least about 0.1 wt. % and even more commonly from about 0.15 to about 0.8 wt. % of the peroxygen compound, commonly at least about 0.2 wt. % and even more commonly from about 0.3 to about 0.8 wt. % of the silicate, commonly at least about 0.01 wt. % and even more commonly from about 0.05 to about 0.08 wt. % of the builder, commonly at least about 0.002 wt. % and even more commonly from about 0.005 to about 0.008 wt. % of the surfactant, and commonly at least about 0.001 wt. % and even more commonly from about 0.001 to about 0.08 wt. % of the chelate.

Although an additive composition can be formulated in a manner of U.S. Pat. Nos. 6,043,207 and/or 6,194,367, the present invention is not limited to the composition of matter and/or the method of preparation taught therein.

Removal of Hydrocarbon Materials from a Well

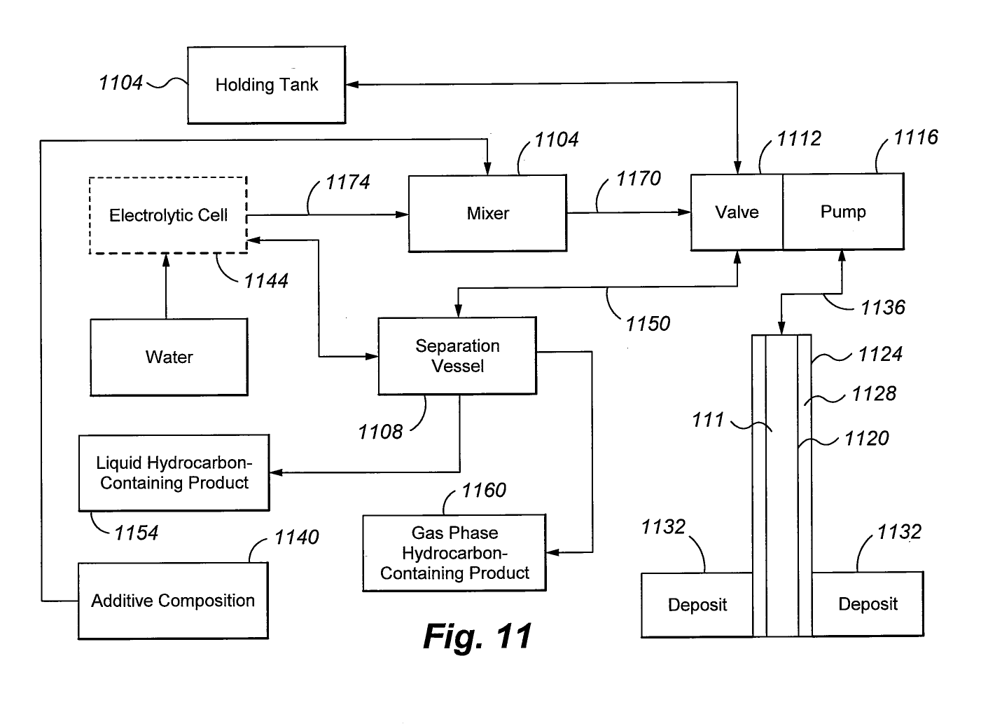

FIG. 11 depicts a process configuration according to an embodiment. The process configuration includes a mixer 1100, holding tank 1104, separation vessel 1108, valve 1112, and pump 1116. The pump 1116 pressurizes and introduces into the well 100 a liquid additive composition. The well can have any configuration but typically includes an inner and outer tubing string 1120 and 1124 forming an annulus 1128 and internal volume 111. The annulus 1128 and internal volume 111 are in fluid communication with a hydrocarbon-containing formation 1132. In one application, a hydrocarbon material has formed numerous blockages or partial blockages in the annulus 1128 and/or internal volume 111 and/or the perforations in the tubing strings 1120 and/or 1124 and/or in the pores and/or fractures of the formation 1132, causing reduced hydrocarbon production flows from the formation to the well head 1136. In one application, removal of the hydrocarbon material from the well is impaired for other reasons, such as low formation pressures, high hydrocarbon viscosity, and the like. In one application, hydrocarbon material has been recovered by conventional techniques but significant quantities of hydrocarbon materials remain in the underground formation that are not economically recoverable by such techniques.

These and other problems are addressed by the additive composition. To form the liquid additive composition, the additive composition 1140, which is in the form of a free flowing powder, is mixed in mixer 1104 with water. The mixer 1104 preferably is a stirred tank vessel.

The water can be from any suitable water source, such as a surface body of water, a subsurface body of water, with an aquifer being exemplary, or the well 100 itself. The well 100 produces produced water, which is recovered in the separation vessel 1108 as discussed below. Produced water typically includes not only water but also various salts, such as potassium chloride, sodium chloride, and sodium carbonate.

The water is optionally treated by one or more electrolytic cells 1144 to impart an added electron, or negative charge, to the water molecule. The negative charge is believed to enhance the effectiveness of the liquid additive composition in solubilizing hydrocarbons. While any electrolytic cell may be employed, preferred cells include ionizing and chloralkali cells. As will be appreciated, the ionizing cell, unlike the chloralkali cell has no semi-permeable membrane positioned between the anode and cathode. While not wishing to be bound by any theory, the electric current passing through the cell is believed not only to impart an added electron to the water molecule but also to convert some water molecules into hydrogen gas and hydroxyl ions and alkali metal chloride salts into alkali metal hydroxides and chloride gas. A vapor recovery system collects the chlorine and hydrogen gases as separate products. The hydrogen gas may be added to any gaseous hydrocarbons (e.g., natural gas) recovered from the well 100.

In the mixer, the additive composition is mixed with the ionized water 1174 to form a liquid additive composition 1170. In one formulation, the liquid additive composition 1170 comprises from about 0.1 to about 0.3 wt. % of a peroxygen compound, from about 0.15 to about 0.4 wt. % of a silicate, from about 0.1 to about 0.3 wt. % of a builder, from about 0.001 to about 0.002 wt. % of a surfactant, and from about 0.001 to about 0.003 wt. % of a chelate. The liquid additive composition has a preferred pH in the range of from about pH 12 to about pH 13. The liquid additive composition typically has an oxidation potential of at most about −100 mV versus SHE and/or a surface tension commonly of at most about 30 dynes. Additionally, the liquid additive composition typically has a Na₂O milliequivalent (meq) value at a pH of about pH 8 of at least about 20 meq.

The liquid additive composition 1170 is removed from the mixer 1104 and passed, via valve 1112 and pump 1116, into either the annulus 1128 or internal volume 111 of the well 100. The liquid additive composition may be pumped out of the well 100 and directed, by valve 1112, to a holding tank 1104 and then pumped back into the well 100. This process may be repeated in a number of cycles as desired.

While in the well 100, the liquid additive composition solubilizes and removes hydrocarbons, such as oil, paraffins, alphaltenes, kerogen, malthas, gilsonites, tars, bitumen; and/or mixtures thereof. The hydrocarbon-containing liquid additive composition, including the solubilized hydrocarbons, is removed by pump 1116 and directed, by valve 1112, to the separation vessel.

The hydrocarbon-containing liquid additive composition includes a number of different components. It normally includes the water carrier, additive composition, various salts (such as alkali metal chlorides and carbonates), solubilized liquid- and gas-phase hydrocarbons (e.g., oil, paraffins, asphaltenes, kerogen, bitumen, lead pellets, calcium salt, and other substances that may have caused well skin damage), and other compounds and particulates. In a typical application, the amount of hydrocarbons dissolved in the composition is at least about 6 wt. % and even more typically ranges from about 8 to about 10 wt. %.

In the separation vessel 1108, the gas-phase hydrocarbons are vented off as a gas-phase hydrocarbon-containing product 1160 (which may be combined with hydrogen gas produced by the electrolytic cell 1144) and the remainder of the hydrocarbon-containing liquid additive composition 1150 is permitted to fractionate into three layers. The upper layer comprises at least most of the lighter hydrocarbons, including oil, paraffins, bitumen, and kerogen, in the composition 1150, the middle at least most of the dissolved additive composition and produced water in the composition 1150, and the lower layer at least most of the heavier hydrocarbons, including asphaltenes, and solid-phase components, such as particulates.

A wax float can further concentrate lighter hydrocarbons in the upper layer.

The various phases can be removed separately from the separation vessel 1108 to form a hydrocarbon-containing product 1154 containing at least most of the hydrocarbons in the composition 1150. The product 1154 can be further processed by known techniques to form concentrated fractions of the various hydrocarbons.

The middle layer containing the additive composition and produced water is recycled to the electrolytic cell 1144. As needed, additional additive composition and/or components thereof are added to the mixer to maintain desired concentration levels of the various composition components.

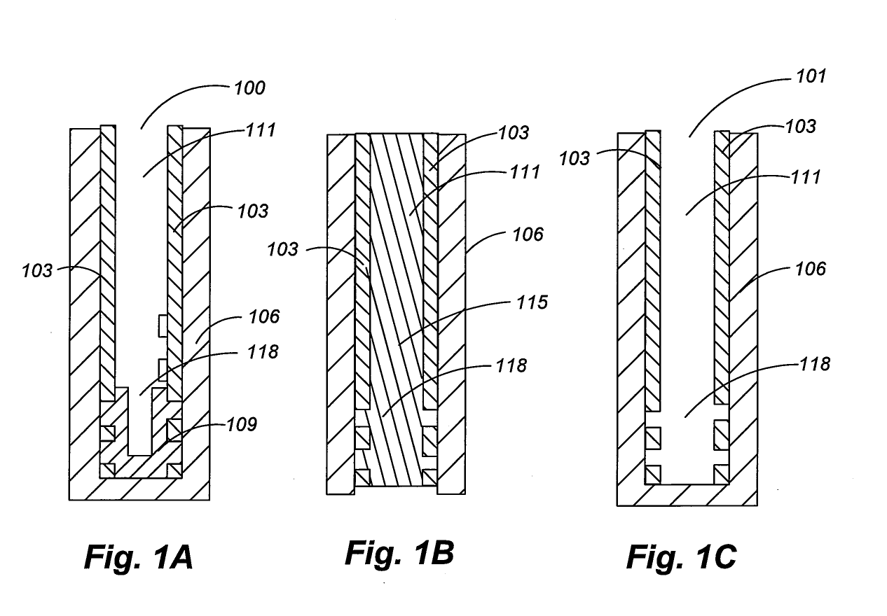

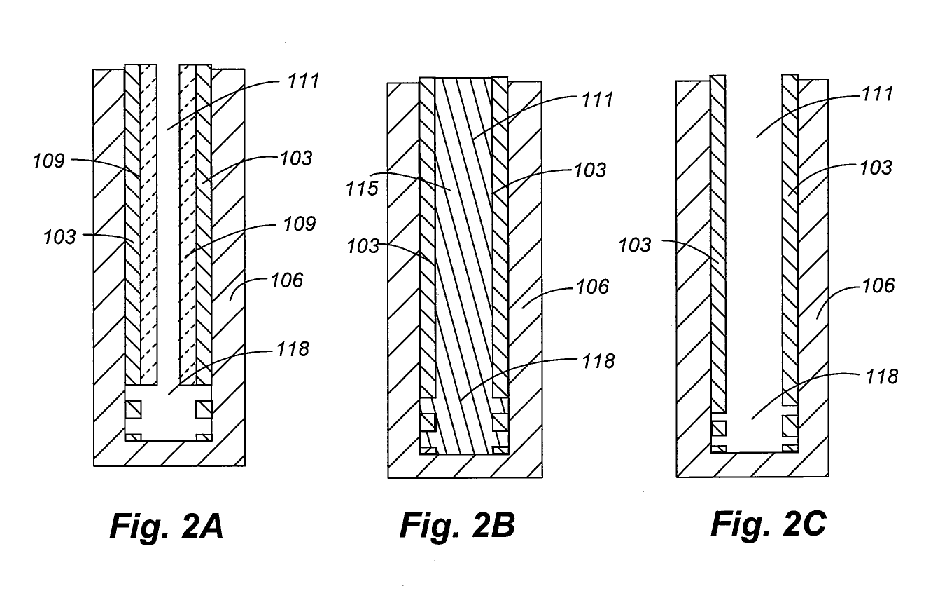

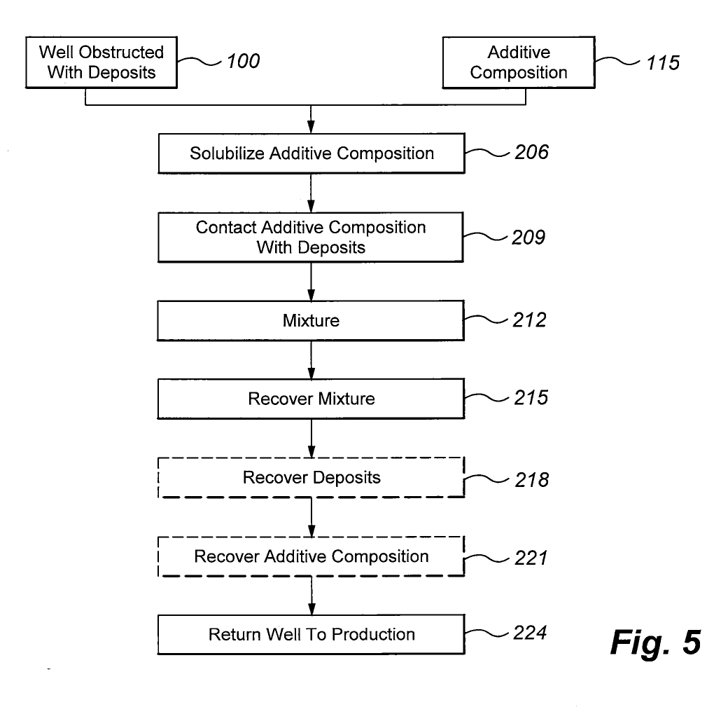

In another embodiment, FIGS. 1A, 2A, and 5 depict a process of using an additive composition 115 to treat an obstructed well 100 having a tubing string (and/or production casing) 103, an internal volume 111, and a production zone 118 (FIG. 1A) and/or internal volume 111 (FIG. 2A) restricted and/or plugged with a deposit 109. The deposit 109 comprises a single continuous deposit 109 or a plurality of deposits 109 within well 100. Typically, the deposit 109 comprises one or more components. Common components of the deposit 109 are: paraffins; asphaltenes; malthas; gilsonites; tars; bitumenes; biomasses (as for example, bacteria, such as, anaerobic sulfate reducing bacteria); and mixtures thereof. It can be appreciated that, the deposit 109 reduces and/or impedes the flow of petroleum into the production zone 118 and/or within the internal volume 111 of the production string 103.

In step 206, the additive composition is solubilized to form a liquid solution 115 containing the additive composition. This is shown in FIG. 1B. The liquid additive composition 115 typically comprises one of an aqueous solution, non-aqueous solution, or mixture thereof. An aqueous solution means any water-containing solution, such as, but not limited to, solutions comprising water, brines, ground waters, municipal waters, surface waters, sub-surface waters, sea waters, waters associated with petroleum production, or mixtures thereof. A non-aqueous solution means any liquid which solubilizes the additive composition, such as, but not limited to, alcohols (for example, methanol, ethanol, propanol, butanol, and so forth), polar organics, non-polar organics, or mixtures thereof. The solubilizing step 206 is typically conducted in one of: the internal volume of string 111, a vat or tank external to the internal volume of string 111; or a combination thereof.

In step 209, the liquid additive composition and deposit 109 are contacted for a period of time. While not wanting to be bound by any theory, the period of time varies depending on the type and amount of deposit 109, the contacting temperature, and the liquid additive composition. Typically, the contacting time ranges from about 1 second to about 60 days. Preferred contacting times range from about 5 seconds to about 30 days, and more preferred contacting times range from about 10 seconds to about 14 days. While not wanting to be bound by any theory, the contacting temperature typically affects the contacting time. Commonly, increasing the contacting temperature reduces the contacting time.

The contacting of the liquid additive composition with the deposit 109 forms a mixture 212. The mixture 212 typically comprises the additive composition and at least some of the hydrocarbons in the deposit 109. While not wanting to be bound by any theory, the contacting of additive composition and the deposit 109 commonly forms the mixture 212 by physical and/or chemical processes. The physical process commonly includes dispersing, solublizing, suspending, and/or fragmenting the deposit 109 without substantially changing the chemical structure and/or composition of the component of the deposit 109 being dispersed, solublizied, suspended, and/or fragmented. The chemical process typically includes changing at least some of the chemical structure and/or composition of the component of the deposit 109 being dispersed, solublizied, suspended, and/or fragmented.

In step 215, at least most of the mixture 212 is removed from the internal volume of the string 111 and the wellbore 118. Typically, the removed mixture 212 is recovered at the surface of the obstructed well 100. The recovery of mixture 212 means one of the following: disposal of the mixture 212; commercial sale and/or use of the mixture 212; recovery of one or more of the components of the deposit 109 (step 218); recovery of the additive composition 115 (step 221); or combinations thereof.

FIGS. 1C and 2C depict the cleaned well 101 substantially free of hydrocarbon deposits 109. In step 224, the cleaned well 101 is returned to production. It can be appreciated that the hydrocarbon deposits 109 are substantially removed and petroleum flows substantially unimpeded into the clean wellbore 118 (FIG. 1C) and internal volume 111.

In optional steps 218, one or more of the components of the deposit 109 and/or the additive composition are recovered. For example, step 218 typically comprises recovering any paraffin and/or petroleum components comprising the deposit 109.

In optional steps 221, the additive composition is recovered. In one embodiment the additive composition is recovered by substantially removing one or more of the components of the deposit 109 from the mixture 212. The additive composition can be recycled or reconstituted (by adding one or more constituents comprising the recovered additive composition) to contacting step 209. In another embodiment, one or more of the constituents of the additive composition are recovered, as for example, the: chelator, gelling agent, and/or peroxygen compounds.

While not wanting to be bound by any theory, one method of recovering the deposit 109 components and/or petroleum in step 218 (and/or step 221 for recovering the additive composition) is decreasing the pH of the mixture 212. Typically, the deposit 109 components and/or petroleum form at least one separate phase within the mixture when the pH is decreased. Typically, the pH is decreased to a pH ranging from about a pH 10 to about a pH 2. Preferably, the pH is decreased to a pH ranging from about a pH 8 to about a pH 4. More preferably, the pH is decreased to at least about a pH of about pH 8 and/or a pH of about a pH 4. Another method of recovering the deposit 109 components and/or petroleum (and/or the additive composition) is filtration. Filtration means any filtration separation process, such as, but not limited to: chemical filtration; adsorption; absorption; physical filtration; membrane filtration; ion exchange, size exclusion; reverse osmosis; multimedia filtration; or combinations thereof. Yet another method of recovering the deposit 109 components and/or petroleum is chemical and/or physical separation methods, such as, but not limited to, typical separation methods used within the petroleum industry: oil/water separation process; electrostatic separation; chemical de-emulsification; heat-treatment separation; coalesce; biological process; distillation; steam distillation; phase separation; specific gravity separation techniques (e.g., settling tank and centrifuge), and combinations thereof.

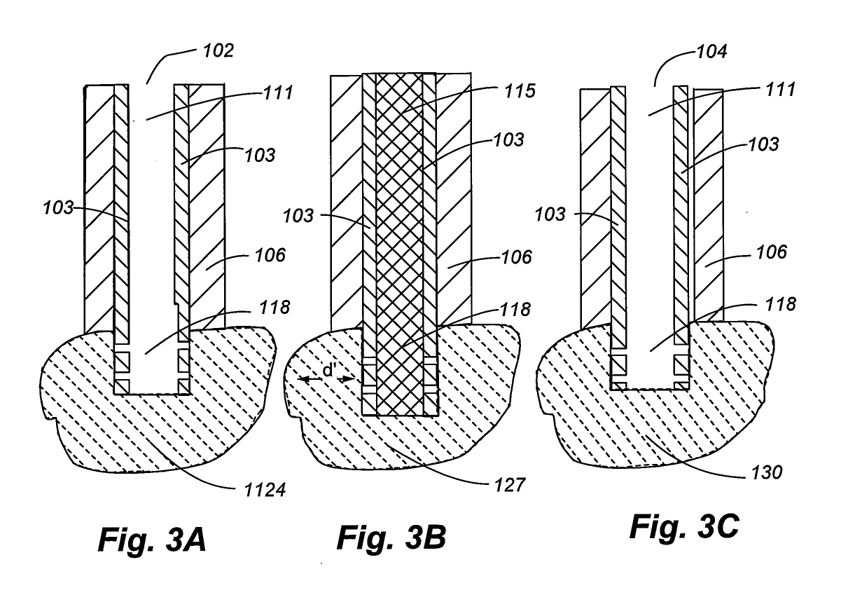

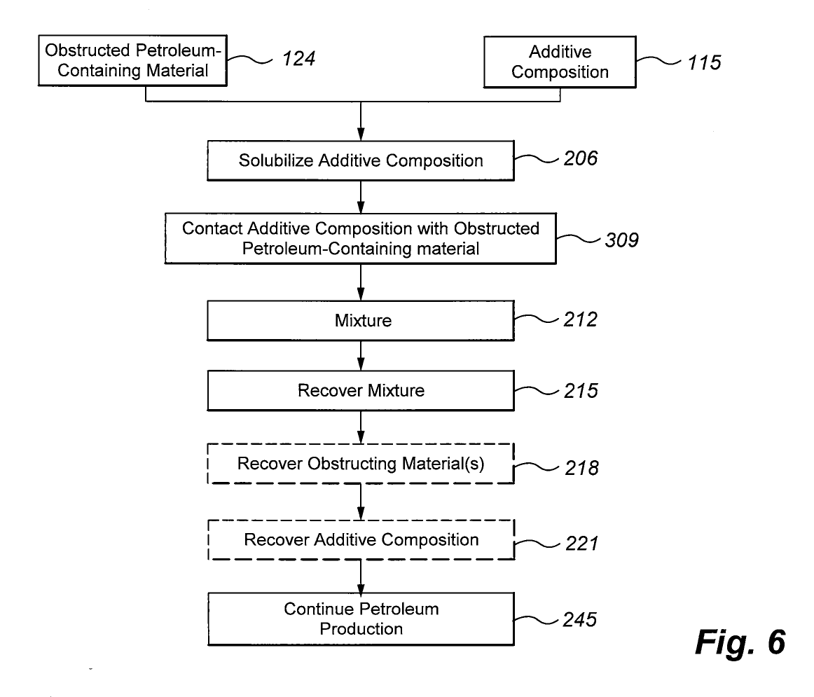

FIG. 6 depicts a process of using the additive composition to treat an obstructed petroleum-containing material 124. FIG. 3A depicts a well 102 having a tubing string (and/or a production casing) 103 having an internal volume 111, a production zone 118 in a petroleum-containing formation, and the obstructed petroleum-containing formation 124. Typically, the material obstructing the obstructed petroleum-containing formation 124 comprises one or more components. The components typically comprise: paraffins; asphaltenes; malthas; gilsonites; tars; bitumenes; and/or mixtures thereof. It can be appreciated that, the obstructing material commonly reduces and/or impedes the flow of petroleum into the production zone 118.

In step 206, the additive composition is solubilized in a liquid additive composition as described above. In step 309, the liquid additive composition is contacted with the obstructed petroleum-containing formation 124 to form a cleaner-impregnated material 127 (FIG. 3B). The liquid additive composition 115 is contacted with at least some of the obstructing material to form a mixture 212 within the cleaner-impregnated material 127. Typically, the contacting step 309 commonly includes at least physically and/or chemically dispersing, solublizing, suspending, and/or fragmenting the obstructing-material. It can be appreciated that, the contacting step 309 can also include at least physically and/or chemically dispersing, and/or solublizing the petroleum within the cleaner-impregnated material 124. The mixture 212 comprises the dispersed, solubilized, suspended, and/or fragmented obstructing material, petroleum, and additive composition 115.

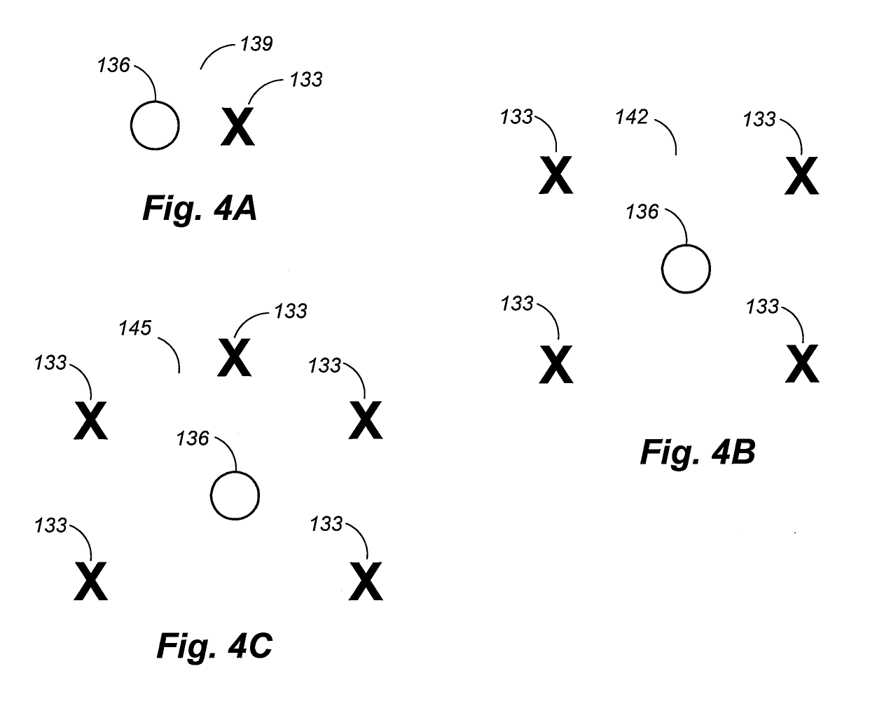

The contacting step 309 typically includes a process of injecting the liquid additive composition 115 into the obstructed petroleum-containing formation 124 to form the cleaner-impregnated material 127. Non-limiting examples of the injecting process of contacting step 309 are: injecting a liquid under pressure; fracturing; and stimulating processes typically practiced with the petroleum production industry. It is appreciated that the injecting process of contacting step 309 comprises injecting the additive composition 115 a distance, ‘d’, from the wellbore 118. The distance, ‘d’, typically ranges from about 3 feet to about 10,000 feet, preferably from about 20 feet to about 8,000 feet. The distance, ‘d’, that the liquid additive composition 115 is injected typically depends on the type of stimulation and/or production process being conducted. Non-limiting examples of petroleum production processes which the liquid additive composition 115 typically provides benefits are:
1) Stimulating the producing formation surrounding the wellbore. That is, typically increasing permeability of the formation surrounding the wellbore by removing the obstructing materials from one or more of pores and/or passageways connecting the pores within the formation.
2) Cleaning obstructed fractures (natural and/or man-made) within the surrounding wellbore.
3) Cleaning obstructed radially and/or horizontally drilled producing bores.
4) Stimulating production in an injection-production process, such as, injecting the additive composition into injection wells 133 (FIGS. 4A-4C) and recovering the dispersed, solublizied, suspended, and/or fragmented obstructing material, petroleum, and liquid additive composition 115 from a production well 136. FIG. 4C depicts a typical injection/production pattern 146 having a plurality of injection wells 133 per production well 136. FIG. 4B depicts a typical 5-spot injecting and producing pattern 142 having four injection wells 133 per production well 136. FIG. 4A depicts yet another injection/production pattern 145 having a single injection well 133 per production well 136.
5) Recovering and/or stimulating petroleum in primary, secondary, and/or tertiary (for example, gas injection, thermal recovery, or chemical injection) recovery processes.

In step 215, the mixture 212 is recovered from the cleaner-impregnated material 127 to form a substantially unobstructed petroleum-containing formation 130. The mixture 212 can be recovered from the same well that the liquid additive composition 115 was injected into (FIGS. 3A-3C) or from the production well 136 after injecting the liquid additive composition 115 into the injection well(s) 133 (FIGS. 4A-4C).

In optional steps 218 and 221, one or more of the components of the obstructing material(s) and/or one or more of the components of the liquid additive composition 115 are recovered as described above.

In step 224, petroleum production continues, by: 1) returning a stimulated formation 130 to production and/or 2) recovering petroleum from production well 136.

While certain of the above embodiments have been discussed with reference to petroleum, it is to be understood that the embodiments apply equally to other hydrocarbons, such as heavy oil, bitumen, kerogen, and natural gas deposits.

Removal of Hydrocarbon Materials from a Conduit

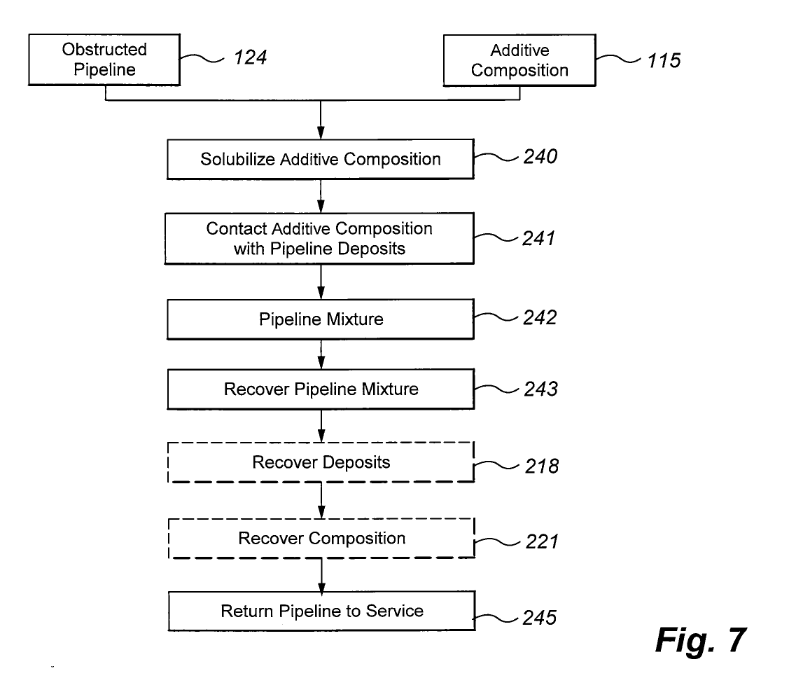

FIG. 7 depicts a process for cleaning an obstructed pipeline 230 or other conduit. The pipeline 201 has an internal pipeline volume 200 obstructed with a deposit 202. Typically, the deposit 202 comprises one or more components. The components commonly comprise: paraffins; asphaltenes; malthas; gilsonites; bitumenes; biomasses (as for example, bacteria, such as, anaerobic sulfate reducing bacteria) and/or mixtures thereof. The deposit 202 typically reduces and/or impedes flow within the internal pipeline volume 200. The deposit is also commonly a site for corrosion activity. The deposit 202 comprises a single continuous deposit 202 or a plurality of deposits 202 within the obstructed pipeline 230.

In step 240, the liquid additive composition 115 is solubilized or dissolved to form a solution 115 of additive composition, as described above. The liquid additive composition 115 is typically prepared in: the internal pipeline volume 200, a portion of internal pipeline volume 200, a vat or tank external to the pipeline 201; or a combination thereof.

In step 241, the liquid additive composition 115 is contacted with at least some of the deposit 202 for a period of time. While not wanting to be bound by any theory, the period of time varies depending on the type and amount of deposit 202, the contacting temperature, and the additive composition 115. Typically, the contacting time ranges from about 1 second to about 4 hours. Preferred contacting times range from about 1 second to about 1 hour, and more preferred contacting times range from about 2 seconds to about 15 minutes. While not wanting to be bound by any theory, the contacting temperature typically affects the contacting time. Commonly, increasing the contacting temperature reduces the contacting time.

The contacting of the liquid additive composition 115 with the deposit 202 forms a mixture 242. The mixture 242 typically comprises the liquid additive composition 115 and deposit 202, wherein the deposit 202 is at least substantially one or more of: dispersed; solubilized; suspended; and/or fragmented (as particles and/or sediment). The contacting of liquid additive composition 115 and the deposit 202 commonly comprises physical and/or chemical processes. The physical process commonly comprises dispersing, solubilizing, suspending, and/or fragmenting the deposit 202 without substantially changing the chemical structure and/or composition of the component of the deposit 202 being dispersed, solublizied, suspended, or fragmented. The chemical process typically comprises changing at least some of the chemical structure and/or composition of the component of the deposit 202 being dispersed, solublizied, suspended, or fragmented.

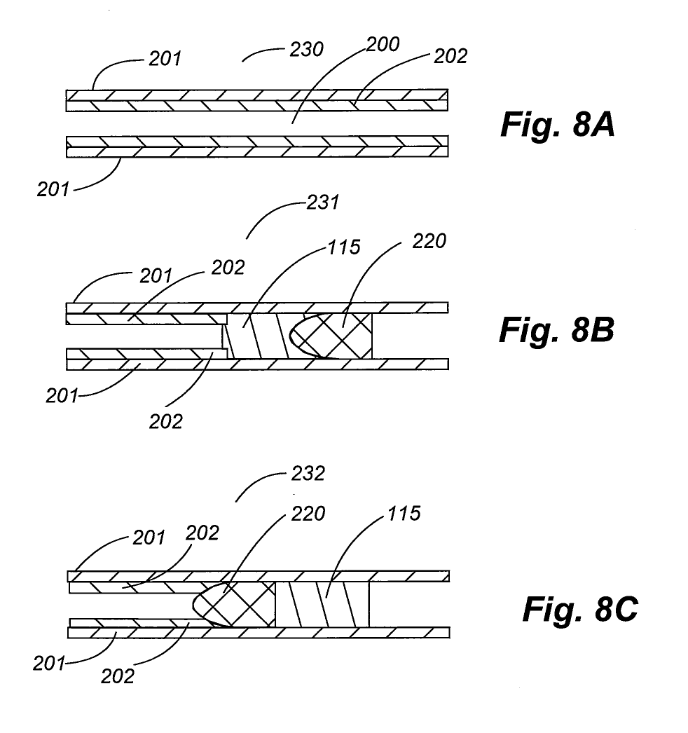

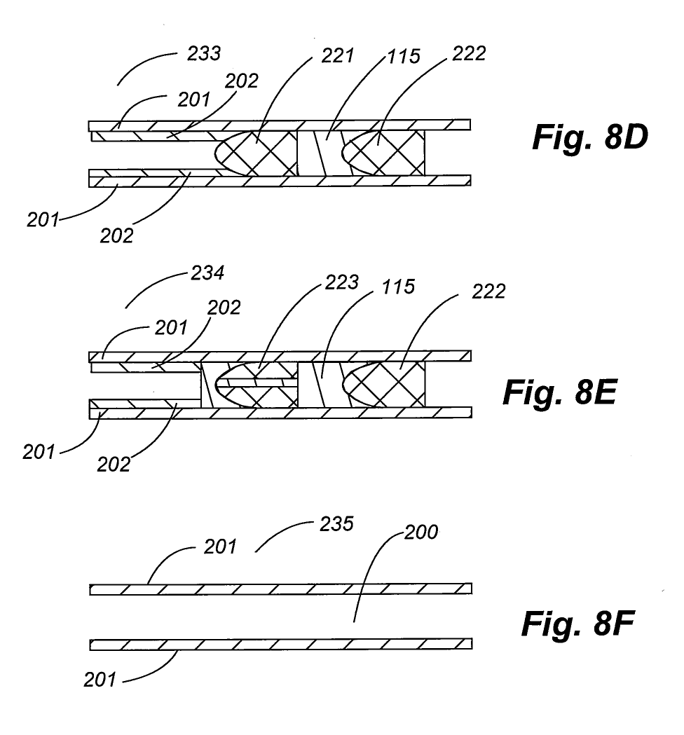

Non-limiting examples of methods of contacting the liquid additive composition 115 solution with the deposit 202 are depicted in FIGS. 8B-8E. FIG. 8B depicts the liquid additive composition 115 positioned in front of at least one pipeline pig 220. The pipeline pig 220 traverses the pipeline 201, pushing the liquid additive composition 115 through the obstructed pipeline 230. It can be appreciated that, the liquid additive composition 115 in front of the pipeline pig 220 contacts the deposit 202 to remove at least some and preferably most of the deposit 202 by forming the mixture 242.

FIG. 8C depicts the liquid additive composition 115 positioned behind the pipeline pig 220. In this configuration, the pipeline pig 220 traverses the pipeline 201 in front of the liquid additive composition 115, the pipeline pig 220 contacting the deposit 202 before the liquid additive composition 115. The additive composition 115 contacts and removes at least some of the deposit 202 not removed by the pipeline pig 220. The deposit 202 is removed by the liquid additive composition 115 in the form of the mixture 242.

Yet another configuration is depicted in FIG. 8D. FIG. 8D depicts the liquid additive composition 115 positioned between first 221 and second 222 pipeline pigs. In this configuration, the first pipeline pig 221 contacts the deposit 202 prior to the liquid additive composition 115 and the second pipeline pig 222. The liquid additive composition 115 disperses, solubilizes, suspends, and/or fragments the deposit 202 to form the mixture 242. The mixture 242 is positioned between the first 221 and second 222 pipeline pigs and is removed from the internal pipeline volume 200 by the second pipeline pig 222. It can be appreciated that the first 221 and second 222 pipeline pigs can be co-joined or separate pipeline pigs, which traverse the pipeline 201.

FIG. 8E depicts another configuration where the liquid additive 115 is positioned between first 223 and second 222 pipeline pigs. In this configuration the first pipeline pig 223 dispenses the liquid additive 115 solution in front of the first pipeline pig 223. Dispense means contacting the liquid additive 115 with the deposit 202 in front of the first pipeline pig 223 by at least one: spraying; jet-spraying; by-passing; metering; or combinations thereof. It can be appreciated that the first 223 and second 222 pipeline pigs can be co-joined or separate pipeline pig entities, which traverse the pipeline 201. An example of a co-joined dispensing pig is a V-Jet® pig manufactured by T. D. Williams, Inc. The V-Jet® pig is designed to spray a liquid to the top quadrant of internal pipeline volume 200. In addition to spraying liquid upwards, the V-Jet® pig has a reservoir for the liquid.

In step 243, at least some of the mixture 242 is recovered from the pipeline 201 forming a clean pipeline 235 (FIG. 8F) having substantially less of the deposits 202 than the obstructed pipeline 230. It can be appreciated that, the mixture 242 can be recovered during: the pipeline pigging process depicted in FIG. 7; a separate pigging process not shown in FIG. 7; and/or returning the pipeline to service (step 245).

In optional steps 218 and 221, one or more of the components of the deposit 220 and/or one or more of the components of the liquid additive 115 are recovered as described above.

### Solution Mining of Hydrocarbons

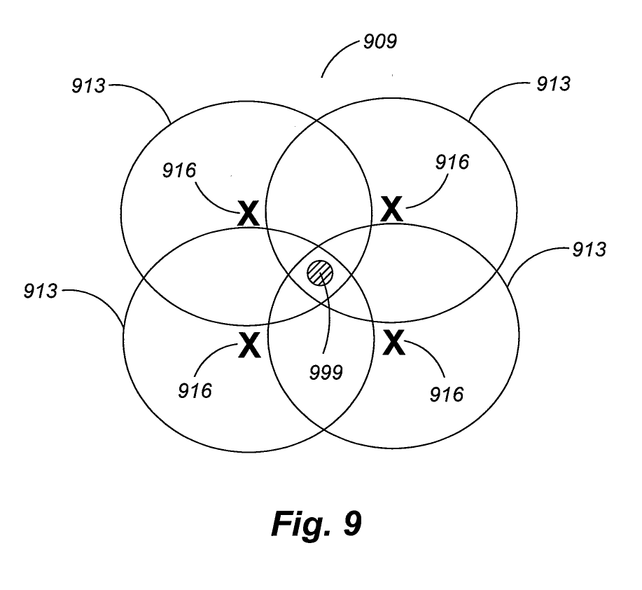

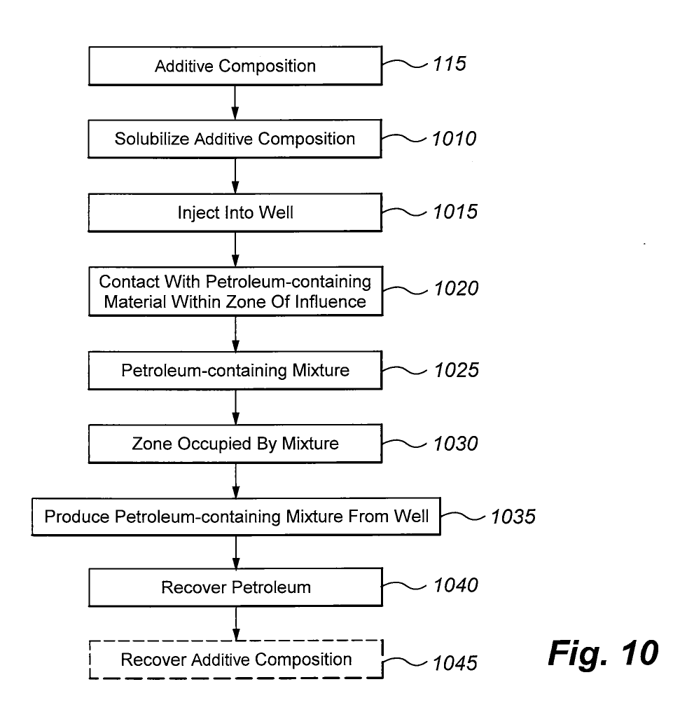

FIGS. 9 and 10 depict another aspect of the invention for recovering hydrocarbons from hydrocarbon-containing materials. “Hydrocarbon” includes, for example, crude oil, shale oil, bitumen, and kerogen. The term hydrocarbon-containing material means any mineral or geological formation containing hydrocarbons, such as, but not limited to limestone, sandstone, oil shale, and tar sand. In step 1010, the additive composition or additive is solubilized to form a liquid additive composition 115, as described above. The solution additive composition 115 typically comprises one of an aqueous solution, non-aqueous solution, or mixture thereof. In one embodiment, aqueous solution means any water containing solution which readily solubilizes the additive, such as, municipal waters (potable and/or reclaimed), surface waters (lake, sea, ocean, river, and/or stream), sub-surface waters (river, stream, and/or well), waters associated with hydrocarbon production, or mixtures thereof. Preferred are aqueous solutions readily available at a hydrocarbon producing site. In another embodiment, the non-aqueous solution means any liquid which solubilizes the additive, such as, but not limited to alcohols, polar organics, non-polar organics, or mixtures thereof. Preferred are alcohols and polar organics.

The solubilizing step 1010 is typically conducted in a vat or tank prior to step 1015, where the solution additive composition is injected into one or more injection wells 916. In step 1015, the solution additive composition 115 is injected into the well and a hydrocarbon-containing material under pressure. The injection pressure is sufficiently great enough for the solution additive composition 115 to permeate the hydrocarbon-containing material. In step 1020, the solution additive composition 115 permeates the hydrocarbon-containing material and contacts hydrocarbons contained within the hydrocarbon-containing material. The contacting of the liquid additive composition 115 typically solubilizes the hydrocarbon within the hydrocarbon-containing material to form a hydrocarbon-containing mixture 1025. In other words, the hydrocarbon-containing mixture 1025 typically comprises hydrocarbon solubilized and/or dispersed within the liquid additive composition 115. While not wanting to be bound by any theory, the contacting of the liquid additive composition 115 with the hydrocarbon typically forms the hydrocarbon-containing mixture 1025 by physical and/or chemical processes. The physical process commonly includes dispersing, solubilizing, suspending, and/or fragmenting the hydrocarbon contained with the hydrocarbon-containing material without substantially changing the chemical structure and/or composition of the hydrocarbon being dispersed, solublizied, suspended, and/or fragmented. The chemical process typically includes changing at least some of the chemical structure and/or composition of at least one component comprising the hydrocarbon being dispersed, solublizied, suspended, and/or fragmented.

In step 1030, the injection of the solution additive composition 115 continues for sufficiently enough time under a sufficiently great enough pressure to form a zone 913.

FIG. 9 depicts a typical 5-spot injection pattern 909 having four injection wells 916 and four zones 913. Each zone 913 represents a volume within the hydrocarbon-containing material occupied by the hydrocarbon-containing mixture 1025. In one embodiment depicted in FIG. 9, a production well 999 is positioned to access a region where the four zones 913 overlap. In another embodiment, the production well 999 is positioned to access a single zone 913 and/or a region where two or more zones 913 overlap. It can be appreciated that, the size and/or shape of zone 913 commonly differs for each injection well 916. The zone 913 for each injection well 916 is typically influenced in part by injection pressure, formation permeability within the zone 913, fracture and/or fault characteristics within the zone 913, and the type of hydrocarbon-containing formations. At least some, if not most of the hydrocarbons within the zone 913 is in the form of the solubilized hydrocarbon-containing mixture 1025. Typically, at least about 2% to at most about 98% of the hydrocarbons within the zone 913 is in contained within the hydrocarbon-containing mixture 1025. More typically, at least about 5% to most about 40% of the hydrocarbon within the zone 913 is contained within the hydrocarbon-containing mixture 1025. It can be appreciated that, the 5-spot injection pattern 909 is an illustrative, non-limiting pattern. The injection 916/production 999 well pattern can be any a pattern or configuration of an injection 916 and production 999 wells. Non-limiting examples of such injection 916/production 999 well patterns are: 1) A single well which operates for a given time as an injection well 916 and then is converted to a production well 999 (that is, the same well is at one time an injection well 916 and at another time a production well 999). 2) A reverse 5-spot pattern, where the injection wells 916 of FIG. 9 are replaced with product wells 999 and the production well 999 of FIG. 9 is replaced by a single injection well 916. 3) A plurality of 5-spot patterns, where at least most of the production wells 999 are surrounded by 4-nearest neighbor injection wells 916 and at least most injection wells are surrounded by 4-nearest neighbor production wells 999. 4) The pattern can be any number of production 999 and/or injection 916 wells. 5) Over time any well can be at one time a production well 999 and at another time a injection well 916.

In step 1035, the hydrocarbon-containing mixture 1025 is produced by production well 999. In step 1040, the hydrocarbon is separated from the hydrocarbon-containing mixture 1025. While not wanting to be bound by any theory, one method of recovery the hydrocarbon from the hydrocarbon-containing mixture 1025 is decreasing the pH of the hydrocarbon-containing mixture 1025. Typically, the hydrocarbon forms at least one separate phase within the mixture when the pH is decreased to a pH ranging from about a pH 10 to about a pH 2. In one preferred embodiment, the pH is decreased to a pH ranging from about a pH 8 to about a pH 4. Another method of recovering the hydrocarbon from the hydrocarbon-containing mixture 1025 is filtration. As defined above, filtration means any filtration separation process. Yet another embodiment of recovering the hydrocarbon from the hydrocarbon-containing mixture 1025 is chemical and/or physical methods, such as, but not limited to, typical separation methods used within the hydrocarbon industry: oil/water separation processes; electrostatic separation methods; chemical de-emulsification methods; heat-treatment separations; coalescing methods; biological processes; distillation methods; steam distillation methods; phase separations; and combinations thereof.

It can be appreciated that, step 1040 can optionally include a step 1045 where the additive composition is recovered. The additive composition can optionally be recovered in a side stream or as a by-product of the hydrocarbon recovery step 1040. The additive composition can also be recovered by the processes and/or methods described above. Additionally, not shown within the FIG. 10, the optionally recovered additive composition can be recycled, such as, being solubilized in step 1010 or (if recovered as a solution) injected into a well in step 1015. The additive composition can be recycled as recovered and/or the recovered additive composition 115 can be partially re-constituted with components to restore the additive 115 to full-strength.

Extraction of Hydrocarbons from Excavated Materials

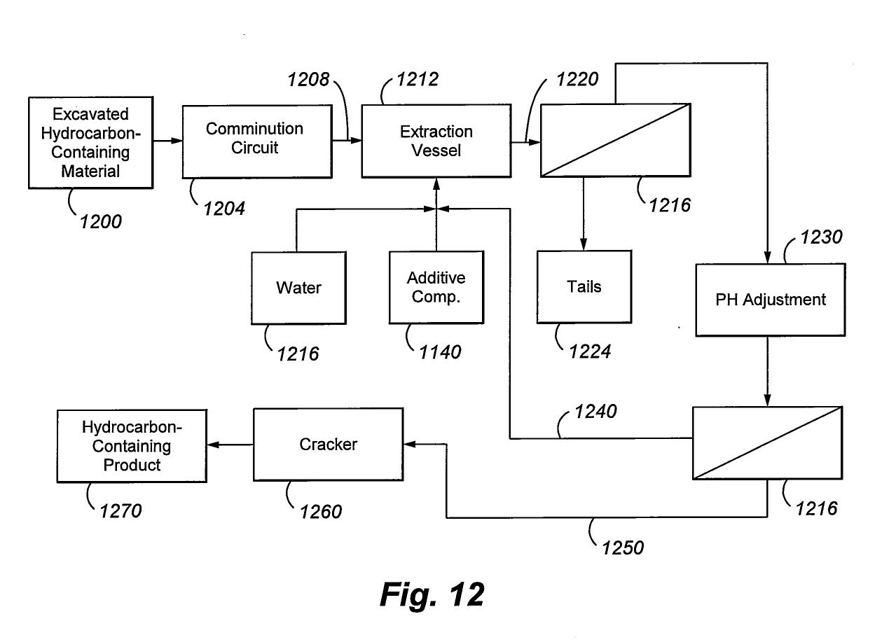

FIG. 12 depicts another embodiment in which hydrocarbon-containing materials are excavated in either underground or surface mines and processed, using the additive composition, to extract the hydrocarbon components.

The excavated hydrocarbon-containing material 1200 includes one or more hydrocarbons, such as oil, bitumen, and kerogen. It is passed through a comminution circuit 1204 to reduce the particle size to a selected mean, median, or P₉₀ size.

The comminuted hydrocarbon-containing material 1208 is placed in an extraction vessel 1212 along with water 1216 and the additive composition 1220. As will be appreciated, the water may be ionized prior to contact with the additive composition 1140. Contact of the water and additive composition may be performed in a separate stirred mixing vessel (not shown), in the extraction vessel 1212, or in a pipe mixer leading to the extraction vessel 1212. The extraction vessel is a stirred tank and may include a heating jacket or shell or other heat source to elevate the temperature of the slurry. The temperature for oil sands, for example, typically ranges from about 80 to about 150° C.

After most of the hydrocarbon content of the comminuted material is dissolved in the liquid additive composition, the slurry is passed through a solid/liquid separator 1216 to form liquid and solid fractions. The liquid fraction includes most of the additive composition and hydrocarbons while the solid fraction contains most of the comminuted particles in the feed stream 1220. The separator 1216 can be any suitable device, including a centrifuge, filter, settling tank, and combinations thereof.

The solid fraction is sent to tails 1224.

The liquid fraction is subjected to pH adjustment in pH adjustment zone 1230 as noted above to cause hydrocarbons to precipitate out of solution.

The resulting slurry is subjected to solid/liquid separation in separator 1216 to form a liquid fraction 1240 containing most of the additive composition and water and a solid fraction 1250 containing most of the hydrocarbons. The liquid fraction 1240 is recycled to the extraction vessel 1212.

The solid fraction 1250 is subjected to cracking in a cracker 1260 to produce a hydrocarbon-containing product 1270.

### EXPERIMENTAL

The property was located in the state of Louisiana. The well site used for testing purposes was in this condition. The well was under a vacuum and being pressurized with 1,000 cu ft of natural gas. In this state, the well was producing 2.5 barrels of oil per day. The well was dedicated for stimulation, and the additive composition disclosed herein (hereinafter the Oil Recovery Crystal Additive or “ORCA”) was selected for the project. Approximately fifty lbs. of ORCA was put into 2,000 gallons of water and solubilized. The solution was then added down hole into the well. The solution remained down hole for about 72 hours. After this period, the solution was pumped back out. The removed solution contained a large amount of sludge (slug). The sludge was put into holding tanks.

The resulting, increased production from the ORCA stimulation was approximately 3,000 cu ft of natural gas per day (an increase of 300%) and 10 barrels of oil per day (an increase of 400%). The production continued for four weeks, but because of hurricane weather problems the well was shut down for a 2-month period.

After the 2-month period, the well was reopened and is now producing daily 8 barrels of oil and 3,000 cu ft of natural gas. This was accomplished through only 1 ORCA stimulation, and it is believed another stimulation could bring even further production.

A number of variations and modifications of the invention can be used. It would be possible to provide for some features of the invention without providing others.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) providing a liquid additive composition, the liquid additive composition comprising a peroxygen compound, a surfactant, and at least about 20 wt. % alkalis; and
(b) contacting the liquid additive composition with a hydrocarbon-containing material to dissolve hydrocarbons in the hydrocarbon-containing material and form a hydrocarbon-containing liquid additive composition.

2. The method of claim 1, wherein the liquid additive composition comprises at least about 0.1 wt. % of the peroxygen compound and at least about 0.001 wt. % of the surfactant.

3. The method of claim 1, wherein the liquid additive composition comprises at least about 0.001 wt. % chelate.

4. The method of claim 1, wherein the liquid additive composition comprises at least about 0.15 wt. % silicate.

5. The method of claim 1, wherein the alkalis comprise a builder that is at least one of a sulfate, carbonate, phosphate, and sesquicarbonate.

6. The method of claim 2, wherein the surfactant comprises a first surfactant having an HLB value of less than about 8 and a second surfactant having an HLB value of greater than about 8.

7. The method of claim 6, wherein the first surfactant is at least one of BioTerg PAS-85™ and Pluronic 25-R-2™ and the second surfactant is at least one of Pluronic L-61™ and Tomadol 91-6™.

8. The method of claim 7, further comprising a fluorocarbon surfactant.

9. The method of claim 1, wherein the providing step comprises the sub-steps:
(A1) applying an electric current to water in at least one of an ionizing cell and a chloralkali cell to produce ionized water; and
(A2) contacting the ionized water with a free flowing additive composition comprising the peroxygen compound and surfactants.

10. The method of claim 1, wherein the hydrocarbon-containing material is at least one of a paraffin and asphaltene, wherein the hydrocarbon-containing material impedes hydrocarbon production from a well, and wherein the contacting step comprises:
(B1) introducing the liquid additive composition to the well; and
(B2) after a selected residence time, removing, from the well, the hydrocarbon-containing liquid additive composition.

11. The method of claim 1, wherein the hydrocarbon-containing material is at least one of oil, bitumen, and kerogen, wherein the hydrocarbon-containing material is contained in an underground formation, wherein a well accesses the underground formation, and wherein the contacting step comprises:
(B1) introducing the liquid additive composition to the well; and
(B2) after a selected residence time, removing, from the well, the hydrocarbon-containing liquid additive composition.

12. The method of claim 1, wherein the hydrocarbon-containing material is at least one of a paraffin and asphaltene, wherein the hydrocarbon-containing material impedes hydrocarbon flow through a pipeline, and wherein the contacting step comprises:
(B1) introducing the liquid additive composition into the pipeline; and
(B2) after a selected residence time, removing, from the pipeline, the hydrocarbon-containing liquid additive composition.

13. The method of claim 1, wherein the hydrocarbon-containing material is at least one of oil, bitumen, and kerogen, wherein the hydrocarbon-containing material is mined from an underground formation, and wherein the contacting step comprises:
(B1) contacting, in a vessel, the liquid additive composition with the mined hydrocarbon-containing material; and
(B2) after a selected residence time, separating a liquid phase of the hydrocarbon-containing liquid additive composition from a solid phase of the hydrocarbon-containing liquid additive composition, the liquid phase comprising the liquid additive composition and solubilized hydrocarbons and the solid phase comprising a processed hydrocarbon-containing material.

14. The method of claim 1, further comprising:
(c) decreasing a pH of the hydrocarbon-containing liquid additive composition to precipitate dissolved hydrocarbons.

15. A composition, comprising:
(f) a peroxygen compound;
(g) a surfactant;
(h) a chelate;
(i) a silicate; and
(j) dissolved hydrocarbons.

16. The composition of claim 15, wherein the peroxygen compound has a concentration ranging from about 0.1 to about 0.8 wt. %.

17. The composition of claim 15, wherein the surfactant has a concentration ranging from about 0.001 to about 0.008 wt. %.

18. The composition of claim 15, wherein the chelate has a concentration ranging from about 0.001 to about 0.008 wt. %.

19. The composition of claim 15, wherein the silicate has a concentration ranging from about 0.2 to about 0.8 wt. %.

20. The composition of claim 15, further comprising from about 0.05 to about 0.3 wt. % of a builder.

21. The composition of claim 15, wherein the hydrocarbons comprise at least one of oil, bitumen, and kerogen.

22. A well, comprising:
(d) a downhole casing;
(e) a wellhead; and
(f) a liquid additive composition in at least part of the downhole casing, the liquid additive composition having the following properties:
a. an oxidation potential of at most about −100 mV versus a standard hydrogen electrode;
b. a surface tension of at most about 28 dynes; and
c. an Na₂O meq value of at least about 20 meq at a pH of about pH8.

23. The well of claim 22, wherein the liquid additive composition comprises a peroxygen compound, a silicate, a builder, a surfactant, and a chelate.

24. The well of claim 22, wherein the well is in fluid communication with a hydrocarbon-containing formation.

25. A pipeline, comprising:
a conduit, the conduit comprising at least one of paraffins, asphaltenes, malthas, gilsonites, and bitumenes; and
a liquid additive composition comprising a peroxygen compound, a silicate, and a surfactant, the liquid additive composition being in contact with the at least one of paraffins, asphaltenes, malthas, gilsonites, and bitumenes.

26. The pipeline of claim 25, wherein a pig is in contact with the liquid additive composition and wherein the liquid additive composition further comprises a builder and a chelate.

27. A liquid mixture, comprising:
(a) one or more low HLB surfactants;
(b) one or more high HLB surfactants;
(c) one or more peroxygen compounds,
(d) dissolved hydrocarbons, wherein at least one of the following is true for the mixture:
an oxidation potential of at most about −100 mV versus a standard hydrogen electrode;
a surface tension of at most about 28 dynes; and
an Na₂O meq value at a pH of about pH 8 of at least about 20 meq.
